(19) United States
(12) Patent Application Publication
(10) Pub. No.: US 2015/0161692 A1
(43) Pub. Date: Jun. 11, 2015

(54) PERFORMINGARTISTSMEET.COM SOCIAL MEDIA WEBSITE FOR CONNECTING ARTISTS, AGENCIES AND FANS

(71) Applicants: DANNIEL TEMBO, WHITEHALL, PA (US); DENISE TEMBO, WHITEHALL, PA (US)

(72) Inventors: DANNIEL TEMBO, WHITEHALL, PA (US); DENISE TEMBO, WHITEHALL, PA (US)

(21) Appl. No.: 14/562,490

(22) Filed: Dec. 5, 2014

Related U.S. Application Data
(60) Provisional application No. 61/912,679, filed on Dec. 6, 2013.

(51) Int. Cl. G06Q 30/06

(52) U.S. Cl. CPC G06Q 30/0601; G06Q 50/01

(57) ABSTRACT

PerformingArtistsMeet.com is a site that has been specially constructed for all types of artists. A site focused on developing and promoting artists by linking them with fans, producers and other artists in one location, streamlined to carter for the artist's individual needs and providing them with tools and challenges that help them excel. The design of the site places artists on an internet World Stage, helping artists familiarize with each other, and above all it brings fans, producers, scouts, agencies, art talent schools, etc., right to the artists. Artists can display their materials in one location, whether they are Models, Comedians, Poets, Musicians, Actresses, Actors, etc. Special tools such as Artists of the Week, and Artists of the Month, places any qualifying artist on everyone's home page, worldwide, throughout that entire week or month. The Book an artist tool provides artists opportunities to perform in places they never imagined.

### CROSS-REFERENCE TO RELATED APPLICATIONS

This application claims the benefit of the following U.S. Provisional Patent Application, which is hereby incorporated by reference in its entirety: U.S. Provisional Patent Application No. 61/912,679 filed Dec. 06, 2013.

### STATEMENT REGARDING FEDERALLY SPONSORED RESEARCH AND DEVELOPMENT

Not Applicable.

### REFERENCE TO SEQUENCE LISTING

Not Applicable.

### BACKGROUND OF INVENTION

This invention relates to creating an on-line community for artists, fans and entertainment industry professionals in the nature of actors, poets, comedians, singers, models, musicians, Ws, producers and music, television and film studio professionals for the purpose of developing, and collaborating on artistic projects, sharing ideas and experiences and participating in discussions regarding professional development and artistic projects.

### SUMMARY OF INVENTION

The idea of creating PerformingArtists.com came about when we realized as artists ourselves, and for other artists as a whole, how difficult it is to get recognized in today's vast entertainment industry. Through our struggles, we saw a great need for a website that would make it a lot easier for artists and their vast talents to be noticed. In creating PerformingArtistsMeet.com we realized that there is no website that communicates promoter, art schools, producers, scouts, etc., known on this website as Agency, with artists and fans. In realizing this huge void, and seeing how difficult it was for us to reach out to promoters and producers through emails and phone calls, the idea of creating a specially designed on-line community website that would place theses Agents, Artists and Fans in direct communication, in one location was born. PerformingArtistsMeet.com was well thought-out and uniquely designed to provide three profiles, one for each category, and provides tools and features that interconnect to bring Artists, Agencies and Fans together; thereby excelling, developing and creating opportunities for Artists and business for Agencies, and also help fans locate artists throughout the world, they never would have imagined existed.

### DESCRIPTION OF FIGURES

FIG. 1 shows a specialized join now and sign in Landing page clearly separating Artists, Fans and Agencies, thus the need of four special buttons. Landing page also flashes the various artist fields supported on this website

FIG. 2 depicts, upper buttons provide two options for join now and sign in for registering Artists and Fans, thus pulling up the registration pop up. Same applies for agency sign up and agency sign in.

FIG. 3 shows the specialized page where artists can choose their art category and will be linked with other artists in that category and this makes it easy for agencies and fans to locate them.

FIG. 4 shows the process during registration all scouts, producers, schools, promoters, agents, etc., termed as Agency are directed to this page to properly complete the registration process and clearly identify the nature of their business. By doing so, artists will easily identify with the Agency when the agency decides to initiate communication with an artist of their interest. Here we can see that Test Modeling School 1000 has identified themselves as a Modeling Agency Company interested in finding aspiring male and female models.

FIG. 5 shows the Login pop up for artists and fans after proper registration to the site is complete and users are ready to entire the site into their specially designated profiles. A similar Login pop up for agencies is available when agencies go to sign in.

FIG. 6 depicts the home page where the artist can choose all courses of action for exploring, and developing their art and bring their dreams to life.

FIG. 7 depicts the amazing Artist of the Week function, a tool that counts the most viewed artist in a given week, and displays this artist on all user website pages giving them publicity throughout the world and opening doors to opportunity.

FIG. 8 shows ultimate achievement, demonstrating Artists of the Month. This achievement provides the highest goal for an artist, giving the artist the capability to be viewed on all user website pages for an entire month worldwide; this tool, Artist of the Month achievement is a pedestal and key in raising the interest of agencies, scouts, school, studios, etc., to see your work and possibly contact the you with various offers.

FIG. 9 depicts the Book This Artists tools that opens doors as it gives the artists a chance to be booked and perform at various venues thereby accelerating the artist career and drawing in other opportunities.

FIG. 10 shows that Continuing to Book This Artists prompts the Book the Artist pop up which will open other windows to complete the process and inform the said artist after the user reads and understands the message in the pop up and presses continue.

FIG. 11 shows the two special chat forums, built in only for artists. Artists can either chat privately, one on one to build and educate each other, or they can schedule special meetings to discuss various industry issues and help each other resolve problems, find solutions and develop.

FIG. 12 shows Refer a Friend allows both the artist and fans to invite other friends to join, and follow the artist from where the request was sent. This helps build the number of fans an artist has, and helps the artist in possibly having the highest views to become Artists of the Week or Artist of the Month.

FIG. 13 depicts when an Agency is logged in they have the capability of viewing all artists, but they can also filter artists by category thereby pin pointing and identifying only the artists of their interest; If an agency is only interested in Dancers or Poets, they can narrow the search as desired.

FIG. 14 show Agencies can build their artist list using the special tool My Artist List. Agents can now easily check on the artist to see how they are developing. Artists in the My Artist List can now be contacted by the agencies and depending on their potential, the artist has high chances of being offered development or production deals.

FIG. 15 shows a Fan's home page, here a fan can follow as many artists as possibly, and the fan also has capabilities to search artists by category. Fans drive and boost the popularity of artists and are a driving force on this website.

### DESCRIPTION OF INVENTION

PerformingArtistsMeet.com is a Social Media Site that has been designed specifically to connect artist, agencies and fans in one location. The site caters to artists needs, development and success, whether they are models, singers, comedians, poets, etc., by providing an on-line community comprising profiles and tools that open doors of communication with other, artists, and direct agencies and fans right to the artists.

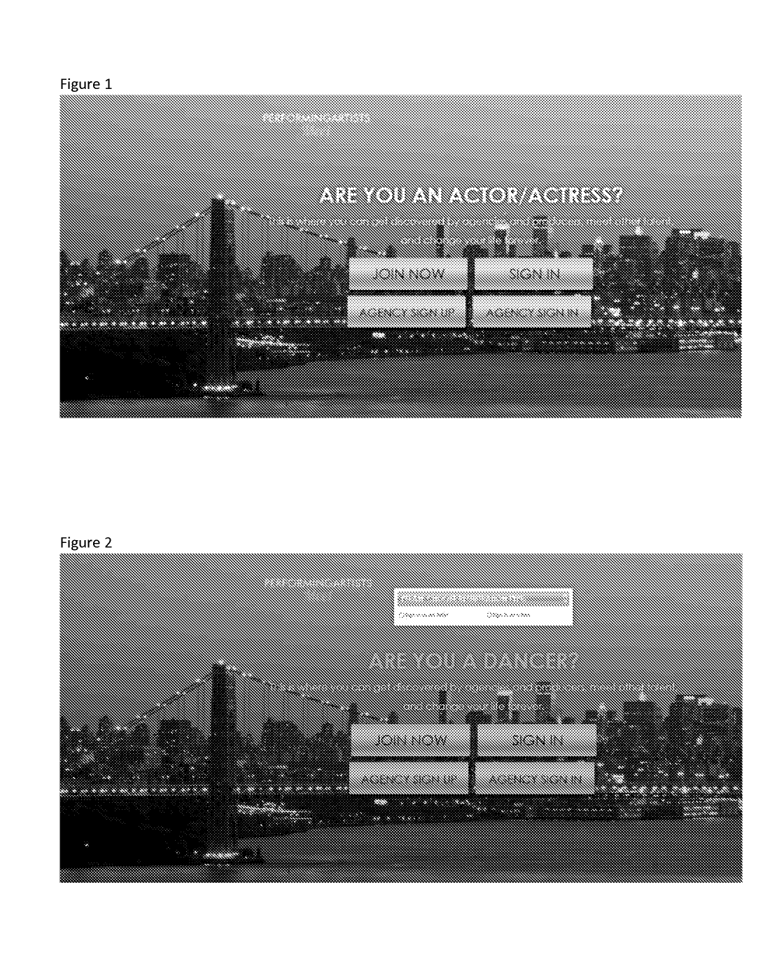

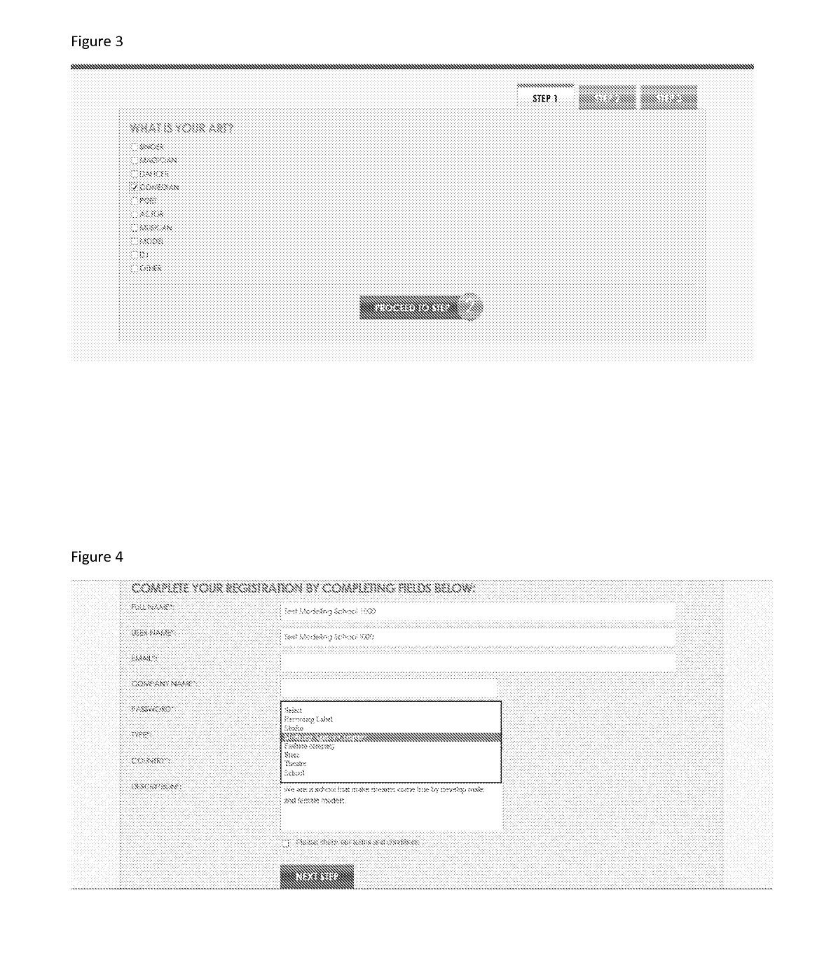

The uniqueness of the site is demonstrated form the Login page shown in FIG. 1, where the website clearly defines itself by providing login buttons for artists, fans and agencies. These buttons provide a dear distinction for joining the site as shown in FIGS. 2, Sign In as an Artist or Sign in as Fan ; FIG. 3 asks an artists to specify their art form; and FIG. 4 prepares an agency to provide their business information. When the various profile information is entered and registration to the site is completed the various users can now be directed to login as shown in FIG. 5. Once logged in the various users are provided with different tools and privileges in their profiles. The uniqueness of these profiles is key in how this website functions and provides unprecedented communication between Agencies, Artists and Fans.

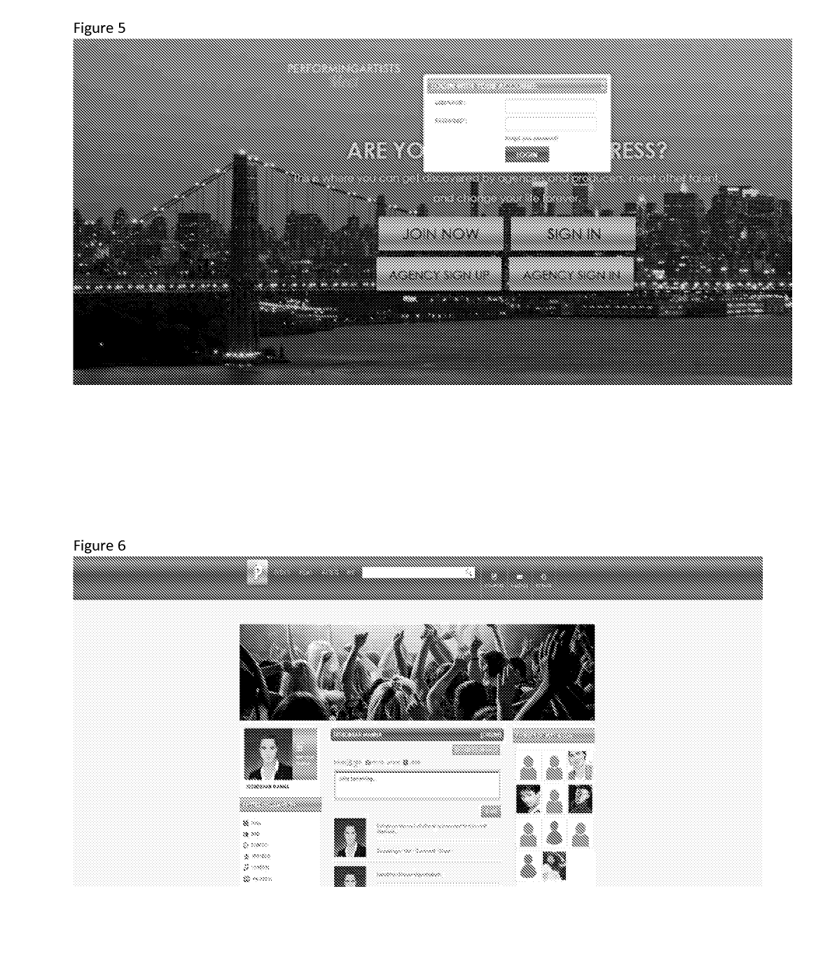

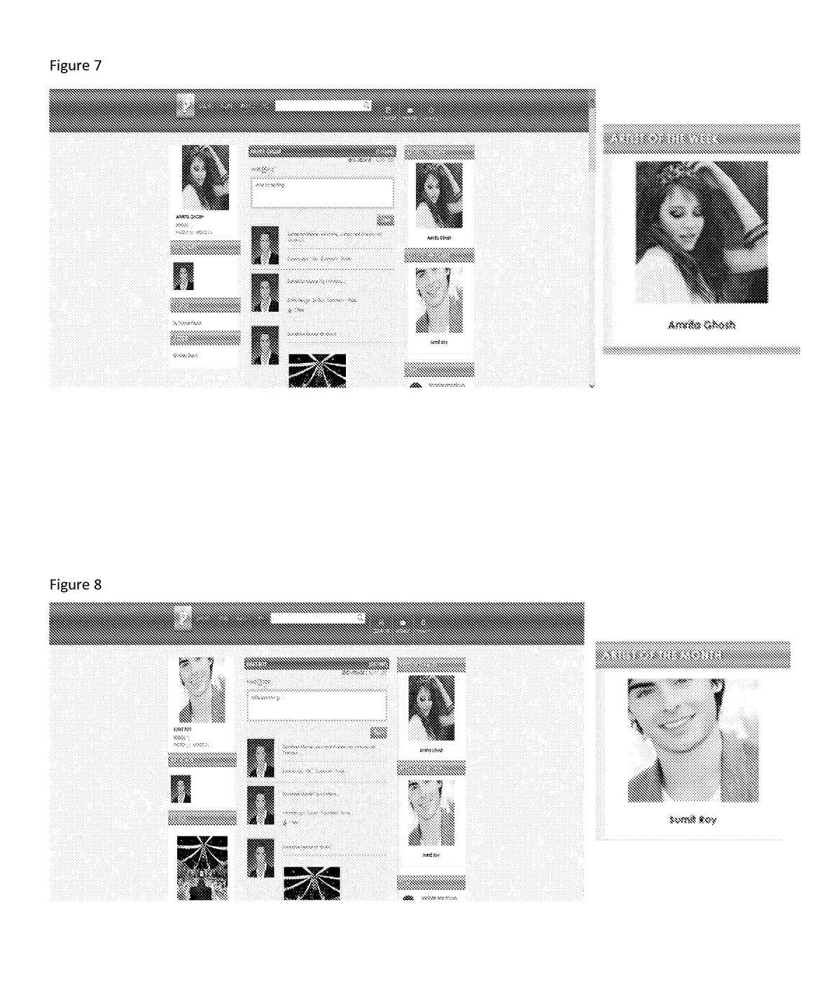

Once logged in the home page, the artist, agency and fan are presented with various tools to build there profiles. As shown in FIG. 6 the artists can now build his or her profile and can also be linked with other artist. FIGS. 7 and 8 show the groundbreaking unprecedented Artist of the Week and Artist of the Month tool functions. These functions highlight some of the most celebrated functions of PerformingArtistsmeet.com, as these features places artists on the Main Stage of the website giving them the presence of a Star. By number of count of visitors to your profile, the site automatically counts the most viewed artist in a given week and month, also known as votes, and displays those said artists on everyone's home page for the entire week or month.

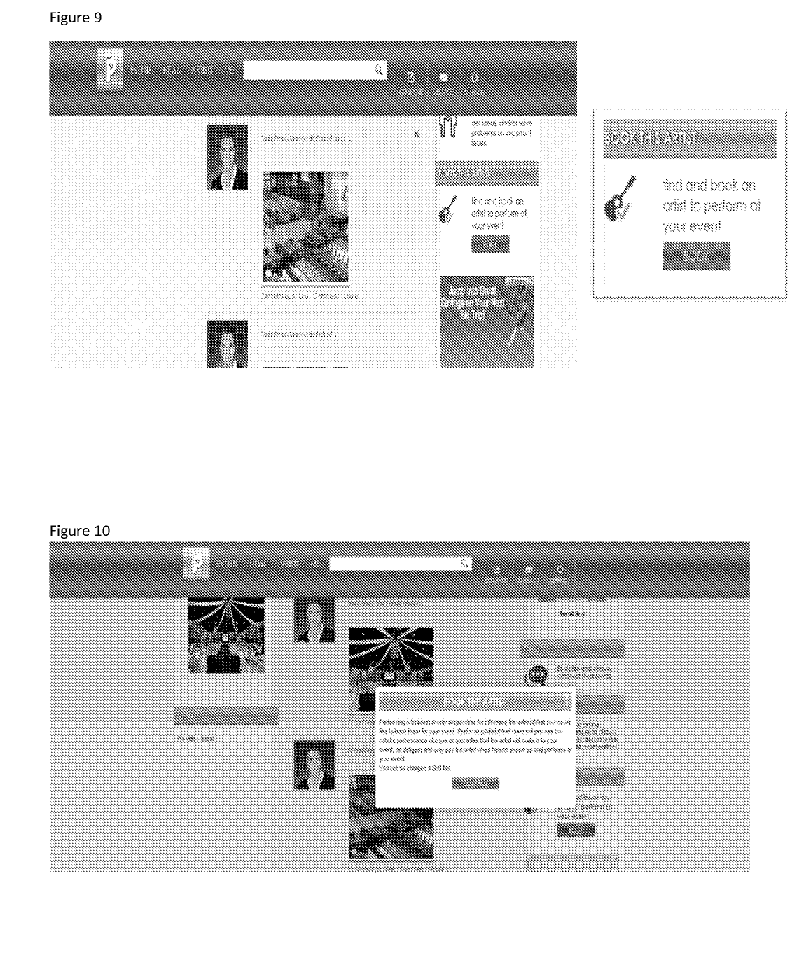

PerformingArtistsMeet.com also has another special tool called Book This Artist, which gives fans the opportunity to book an artist of their interest to perform at their event, be it a birthday party, wedding, company party, anniversary etc. The Book This Artist which opens a popup Book The Artist, shown in FIGS. 9 and 10 gives the artist opportunities to a world of live performances which they never would have imagined.

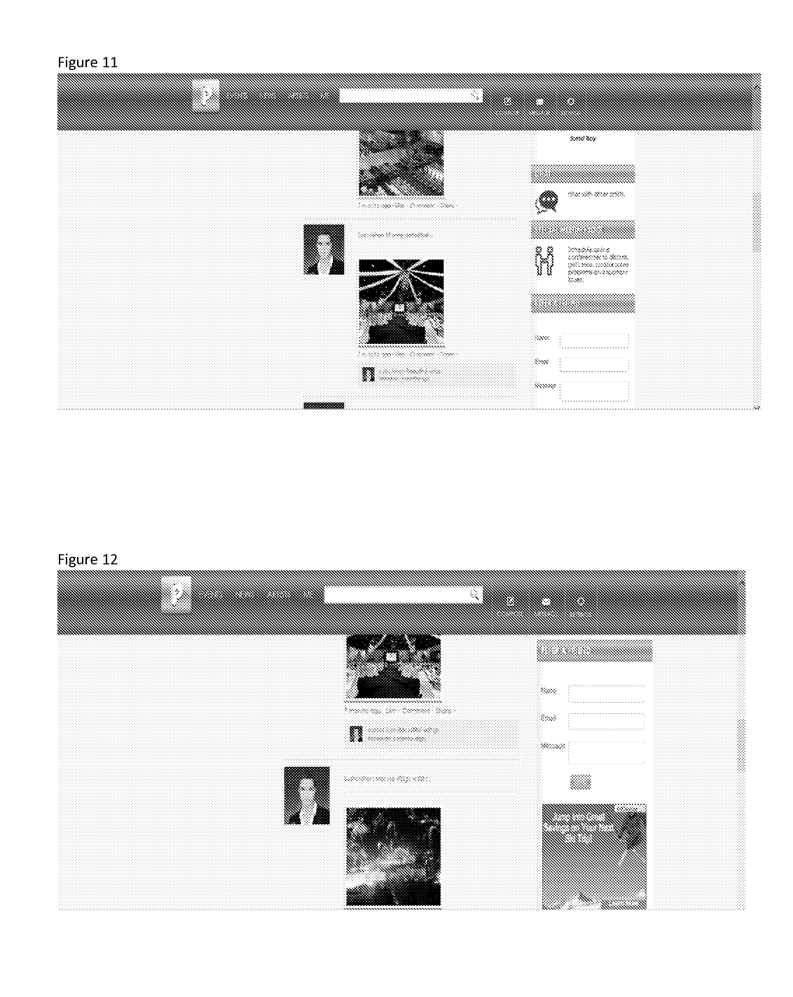

Further there are two separate private chat/meeting rooms on PerformingArtistsMeet.com that are provided only for artists as shown in FIG. 11. The first one is for artists to chat one on one and befriend or build business relationships. The second and extremely special chat room, provides a private meeting platform where artists have the ability to schedule meetings for their category, i.e. poets meeting, to share ideas, discuss problems, and come up with solutions. In providing these special meeting platforms, PerformingArtistsMeet.com is assisting artists find each other to broaden their knowledge of their art and develop with no barriers; no matter where they may be in the world, Anyone who visits an artists page and is impressed by the artist can refer there friend to join the website, and follow an artists as a fan, this is shown in FIG. 12 Refer A Friend.

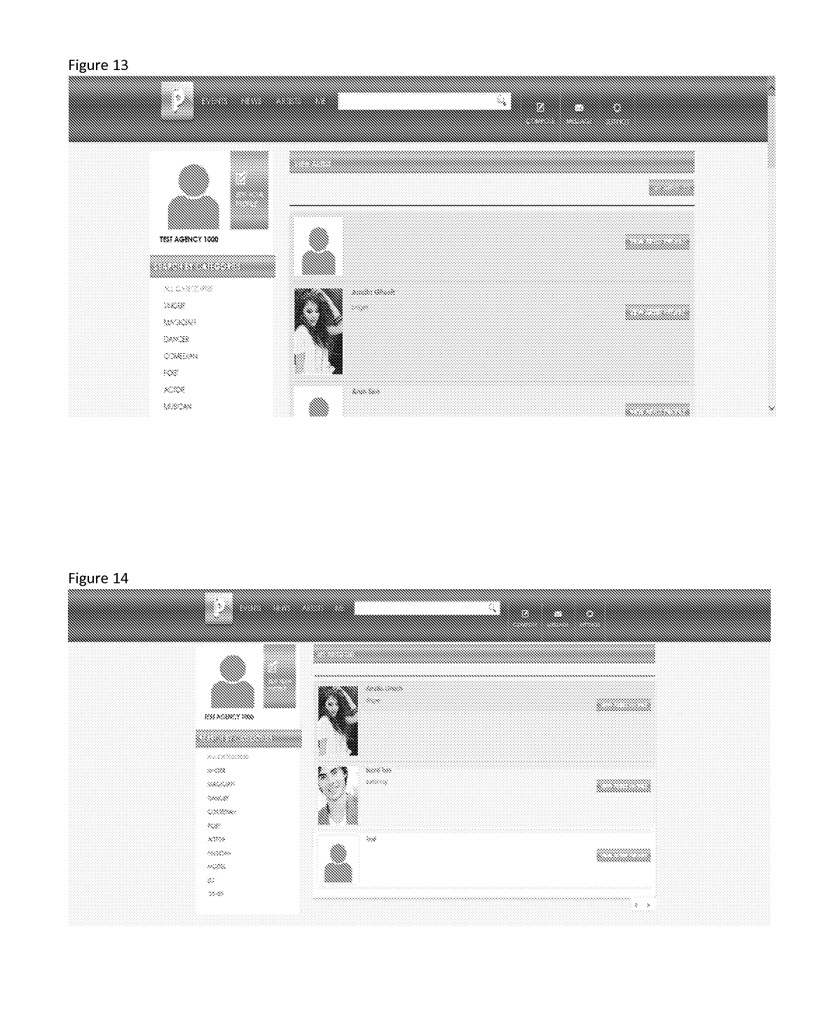

Every Artist's goal is to make it someday, therefore we made sure that we make finding these artists and their potential without having to go to talent shows. On this website the Agency profile is extremely important. As shown in FIGS. 13 and 14, once an Agency is logged in, their profile looks different to that of an artists, but provides tools that easily give them private access to view artist profiles. Agencies can search for all artists or just search by one category, to filter their search. Agencies now have the ability to choose artists they see most appealing in the Search by Category and place them in their My Artist List, shown in FIG. 14. Businesses such as modeling agencies, schools, producers, promoters, talent scouts etc., are also aided immensely by the Artist of the Week, and Artist of the Month Tools, and are assured to view and find the best and most favored artists.

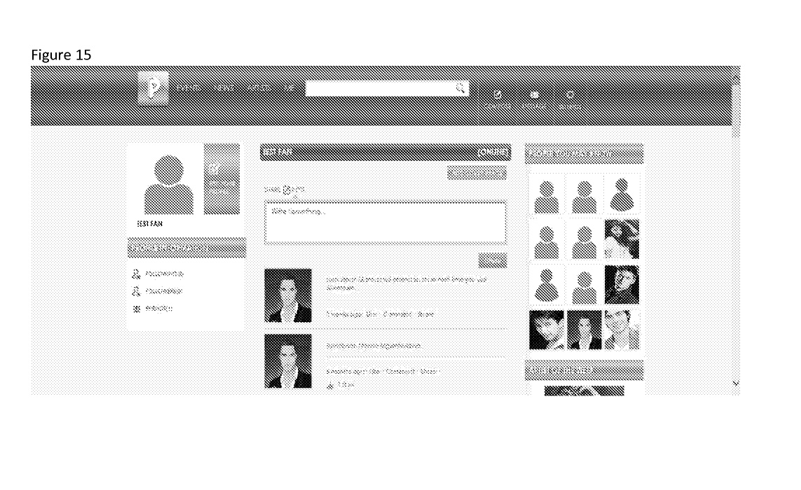

As shown in FIG. 15, a fan can follow his or her favorite artists, cheering them on and seeing how their favorite artists match up with others. PerformingArtistsMeet.com is like a daily live show, where an artist has unlimited opportunities with producers and promoters worldwide, unlike entering talent shows, wait in long lines, for a one time short on stage, and only one producer or promoter to see them. All producers, promoters, scouts, schools, agencies, etc., have full unlimited access to an artist on this site, and all these aspects make PerformingArtistMeet.com extremely unique when it conies to promoting artists and connecting them to fans and agencies, bringing vast opportunities.

The invention claims:

1. I claim said website is specially designed to connect artists, agencies and fans by providing an on-line community that connects artists, agents and fans by use of special joining tools providing three distinct profiles containing different user privileges for artist, agency and fan.

2. As recited in claim 1, website is privileged to connect and provide communication between artists agents and fans and enable artists to gain exceptional recognition throughout the world by showcasing all artist category work in one location and by providing special user joining tools, Join Now for artists and fans, and Agency Sign Up for agencies, and special Sign In for artists and fans, and agency Sign In for agencies as shown in FIG. (1), FIG. (2), FIG. (3), and FIG. (4).

3. As recited in claim 1, joining tools are designed to allow different provisions and clear distinctions for artist, from fan, and from agency thereby providing different profiles for each classification and allowing different privileges in each profile as shown in FIG. (6) for Artist profile, FIG. (13) and FIG. (14) for Agency profile and FIG. (15) for Fan profile.

4. As recited in claim 1, agencies and fans have privileges to view artist profiles and create My Artist List to follow and receive updates on those artists.

5. I claim said website has specially designed tools Artist of the Week and Artists of the Month.

6. As recited in claim 5, and shown in FIG. (7), and FIG. (8) said website gives unprecedented ground breaking publicity for artists by showcasing artists as Artists of the Week, and or Artist of the Month on all user pages.

7. As recited in claim 5, said Artist of the Week and Artist of the Month tools automatically count the number of visitors to artist's page within a specified time period and compares each artist's total views with all other artists, thereby determining the most viewed for the week and the most viewed for the month.

8. I claim website contains special function called Book This Artist which opens popup Book The Artist, website also has a private Chat and special Meeting Tool for artist only.

9. Said claim 8, Book This Artist tool which opens popup Book The Artist shown in FIG. (9), and FIG. (10) allows users on website to book artists of their choice thereby giving artist privileges to the entire world to perform in places artist they never imagined.

10. As recited in claim 8, the Book This Artist tool is further designed to add (10) votes also known as views towards artist weekly or monthly views every time an artist is booked thus helping the artist to achieve Artist of the Week or Artists of the month status in said claim 5.

11. As recited in claim 8, and shown in FIG. (11) website offers special Chat tool reserved only for artist to discuss privately one on one to develop.

12. As recited in claim 8, and shown in FIG. (11) website has Special Meeting Tool which allows artist to schedule a group meeting with artists from their art category to help each other resolve problems and challenges.
